(19) United States
(12) Patent Application Publication
(10) Pub. No.: US 2017/0260804 A1
(43) Pub. Date: Sep. 14, 2017

(54) CLUTCH TYPE CONTROL DEVICE FOR A CORDLESS BLIND

(71) Applicant: BAO SONG PRECISION INDUSTRY CO., LTD., Kaohsiung (TW)

(72) Inventor: WEN-YU WU, Kaohsiung (TW)

(21) Appl. No.: 15/080,559

(22) Filed: Mar. 24, 2016

(30) Foreign Application Priority Data
Mar. 10, 2016 (TW) 105107276

(51) Int. Cl. E06B 9/322; F16D 67/02

(52) U.S. Cl. CPC E06B 9/322; F16D 67/02; E06B 2009/3222

(57) ABSTRACT

Disclosed is a clutch-type control device for a cordless blind, comprising a force-return mechanism and a braking mechanism. The braking mechanism includes an outer housing having an engaging chuck, a shaft connecter having a gearshift lever, and a clutch rotor with a gearshift pattern installed. Disposed on one end of the shaft connecter are a plurality of engaging teeth. The axial distance between the gearshift lever and the engaging chuck is fixed. The gearshift pattern has a blind-lowering disengagement position, a blind-lifting disengagement position, and a blind-stopping engagement position to position the gearshift lever so that the clutch rotor corresponding to the shaft connecter may be operated with axial movement. The engaging teeth of the clutch rotor may be engaged with or disengaged from the engaging chuck of the outer housing. Thereby, the stop height of cordless blind is accurately controlled and operation safety further is enhanced.

### FIELD OF THE INVENTION

The present invention relates to a control device for a cordless blind and more specifically to a clutch-type control device for a cordless blind.

### BACKGROUND OF THE INVENTION

To move up and down for early control devices of cord-type blinds is to install a braking controller on one side of the rail on top of the blind where a bead chain or a pulling line installed on and hanging from the breaking controller. However, the bead chains have caused accidental death of children at home from time to time where the heads of children were hung by the bead chains leading to death. Thus, the cord-type blind have been forbidden to be used indoors in various countries. Therefore, cordless blinds become the major products in the market. There are different designs of cordless blinds, however, the control of up-and-down movement is still not as convenient as the cord-type blinds.

The operation of known cordless blinds is either fully open or fully close. In order to stop a cordless blind at any positions, a balance weight lever installed at the bottom of the cordless blind becomes very important. Moreover, the breaking mechanism or a balanced weight lever of a cordless blind has to be customized where the weight and the dimension of the cordless blinds have to be confirmed then a corresponding breaking mechanism and a balanced weight lever may be designed and manufactured. Any mismatched designs may either cause the cordless blind to suddenly drop during operation causing injured accidents or cause the cordless blind to fully open without stopping at the desired position. Furthermore, the control device of the existing cordless blind comprises a force-return mechanism and a breaking mechanism with a damping spring. However, when the elastic element installed inside the force-return mechanism or inside the breaking mechanism becomes mechanical fatigue, the cordless blind may not keep at fully open nor fully close. In addition, when the cordless blind is set at a desired position, the cordless blind may retract a little bit which causes inconvenience and disturbance to users.

### SUMMARY OF THE INVENTION

The main purpose of the present invention is to provide a clutch-type control device of a cordless blind to accurately control the stopped position and to greatly enhance the safety of cordless blind where the tolerance of the balanced weight may be enlarged.

According to the present invention, a clutch-type control device of a cordless blind is revealed, comprising a force-return mechanism and a breaking mechanism. The force-return mechanism includes a base, a first shaft connecter installed inside the base, and an elastic element installed inside the base and connected to the first shaft connecter to provide an elastic return force for retracting the cordless blind. The breaking mechanism includes an outer housing, a second shaft connecter installed inside the outer housing, and a clutch rotor sleeved in the second shaft connecter. The outer housing has an engaging chuck at its inner bottom. Disposed at one end of the clutch rotor are a plurality of engaging teeth. The second shaft connecter has a gearshift lever protruding toward the axle of the second shaft connecter. Whether the second shaft connecter installed inside the outer housing is rotated or stopped, an axial distance between the gearshift lever and the engaging chuck is fixed. A dished gearshift pattern is formed on an outer radial surface of the clutch rotor where the gearshift pattern has a blind-lowering disengagement position, a blind-lifting disengagement position, and a blind-stopping engagement position to provide a serial position movement for the gearshift lever. When the gearshift lever is aligned to either of the blind-lowering disengagement position and the blind-lifting disengagement position, the engaging teeth of the clutch rotor are disengaged from the engaging chuck so that the second shaft connecter is under rotatable condition. When the gearshift lever is aligned to the blind-stopping engagement position, the engaging teeth of the clutch rotor are engaged with the engaging chuck of the outer housing so that the second shaft connecter is under nonrotatable condition.

The clutch-type control device of a cordless blind revealed in the present invention accurately controls the stopped position disregarding the mechanical fatigue of the force-return mechanism where the tolerance of the balanced weight may be enlarged and the safety of cordless blind may be further enhanced. The clutch-type control device of the cordless blind revealed in the present invention further has the following advantages and effects.
1. In the clutch-type control device of the cordless blind revealed in the present invention, users only need to pull and lift the balanced weight lever to change the shifting position of the gearshift lever of the second shaft connecter in the gearshift pattern of the clutch rotor to change the axial movement of the clutch rotor to control the second shaft connecter in lock or in rotation to move the cordless blind up, down, or still. When the cordless blind is still, two time lowering operation of the cordless blind is able to stop the blind again. When the cordless blind is up, one time lowering operation of the cordless blind is able to stop the cordless blind leading to easy operation.
2. In the present invention, the second shaft connecter is protected by the outer housing to limit its axial movement and the clutch rotor rotationally interlocked to the second shaft connecter can move axially relative to the second shaft connecter according to the aligned position of the gearshift lever in the gearshift pattern to control the rotation of the second shaft connecter since the axial distance between the gearshift lever and the engaging chuck is fixed so that users may precisely control the up and down position of the cordless blind.

### DESCRIPTION OF THE DRAWINGS

FIG. 1 is a three-dimensional assembly view illustrating a clutch-type control device for a cordless blind according to the first embodiment of the present invention.

FIG. 2 is a three-dimensional partial cross-sectional view illustrated the breaking mechanism of the clutch-type control device according to the first embodiment of the present invention.

FIG. 3 is a component disassembly view illustrating the force-return mechanism of the clutch-type control device according to the first embodiment of the present invention.

FIG. 4 is a component disassembly view illustrating the breaking mechanism of the clutch-type control device according to the first embodiment of the present invention.

FIG. 5 is a cross-sectional view component view illustrating the breaking mechanism of the clutch-type control device before joining to the second shaft connecter according to the first embodiment of the present invention.

FIG. 6 is an illustration of a serial position movement of the gearshift lever of the second shaft connecter in the gearshift pattern of the clutch rotor of the clutch-type control device according to the first embodiment of the present invention.

FIG. 7 is an illustration of the position of the clutch rotor of the clutch-type control device corresponding to the outer housing when the cordless blind is lowered according to the first embodiment of the present invention.

FIG. 8 is an illustration of the position of the clutch rotor of the clutch-type control device corresponding to the outer housing when the cordless blind is lifted according to the first embodiment of the present invention.

FIG. 9 is an illustration of the position of the clutch rotor of the clutch-type control device corresponding to the outer housing when the cordless blind is stopped according to the first embodiment of the present invention.

FIG. 10 is a three-dimensional assembly view illustrating another clutch-type control device for a cordless blind according to the second embodiment of the present invention.

FIG. 11 is a component disassembly view illustrating the another clutch-type control device according to the second embodiment of the present invention.

FIG. 12 is a three-dimensional assembly view illustrating another clutch-type control device for a cordless blind according to the third embodiment of the present invention.

FIG. 13 is a component disassembly view illustrating the another clutch-type control device according to the third embodiment of the present invention.

### DETAILED DESCRIPTION OF THE INVENTION

With reference to the attached drawings, the present invention is described by means of the embodiment(s) below where the attached drawings are simplified for illustration purposes only to illustrate the structures or methods of the present invention by describing the relationships between the components and assembly in the present invention. Therefore, the components shown in the figures are not expressed with the actual numbers, actual shapes, actual dimensions, nor with the actual ratio. Some of the dimensions or dimension ratios have been enlarged or simplified to provide a better illustration. The actual numbers, actual shapes, or actual dimension ratios may be selectively designed and disposed and the detail component layouts may be more complicated.

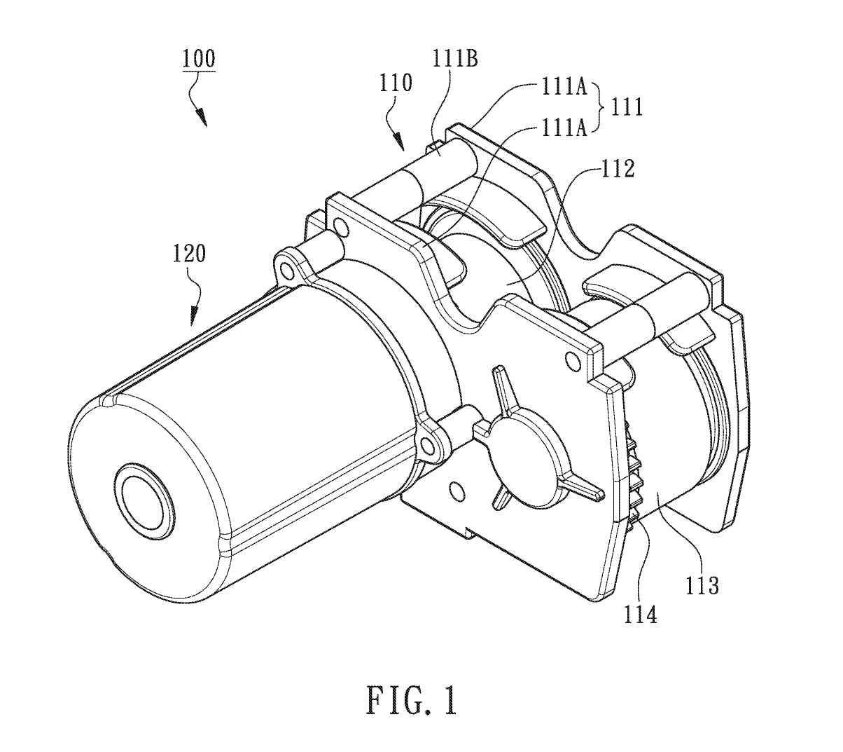

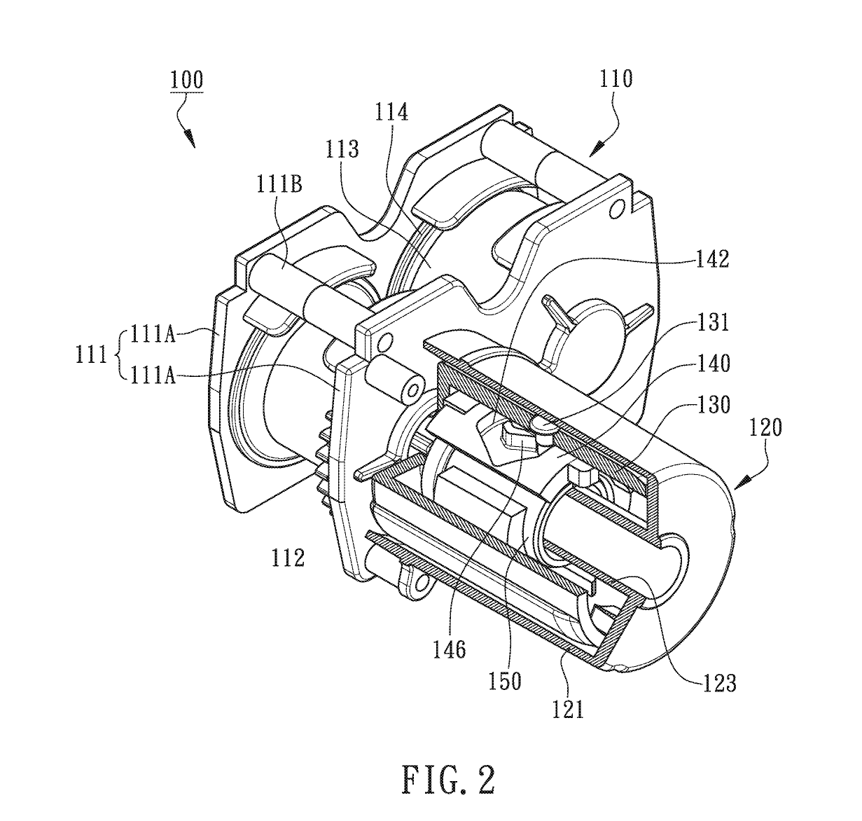

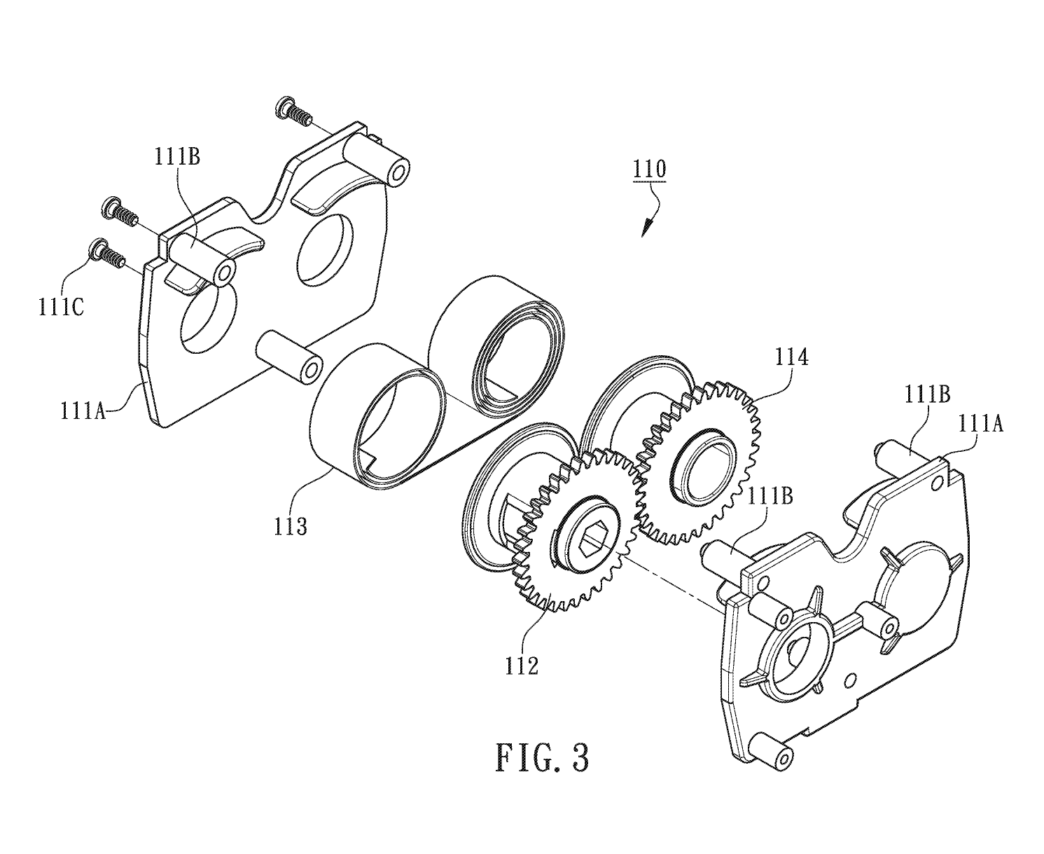

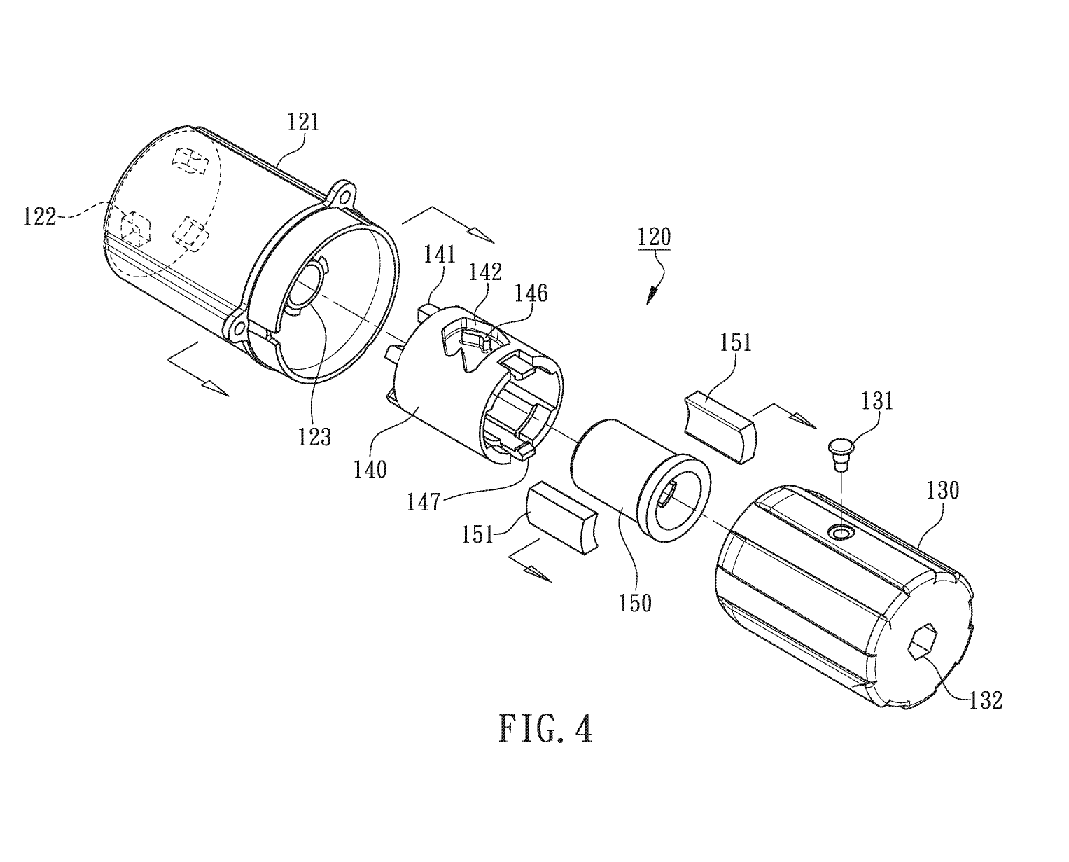

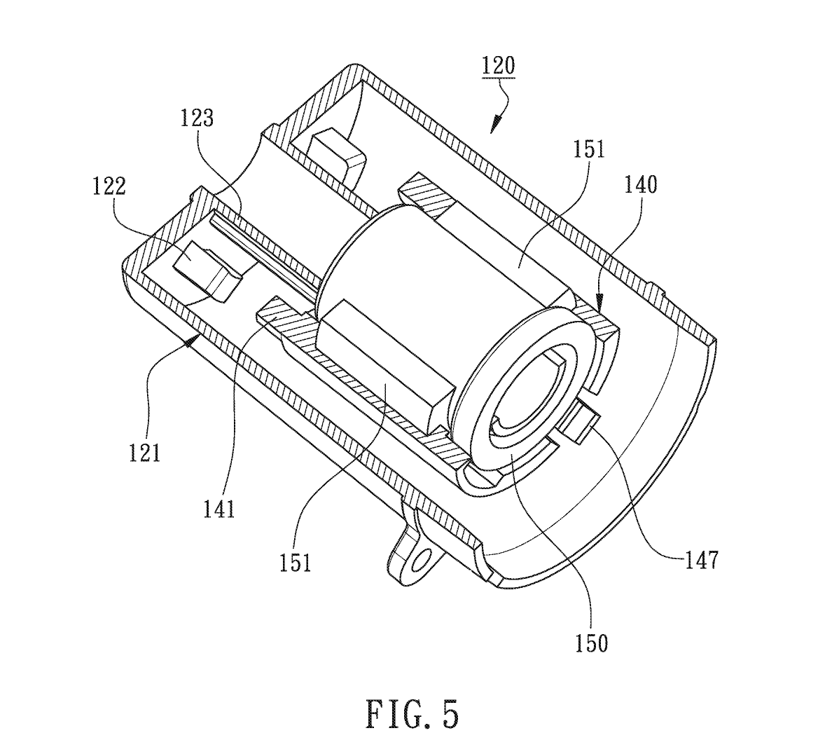

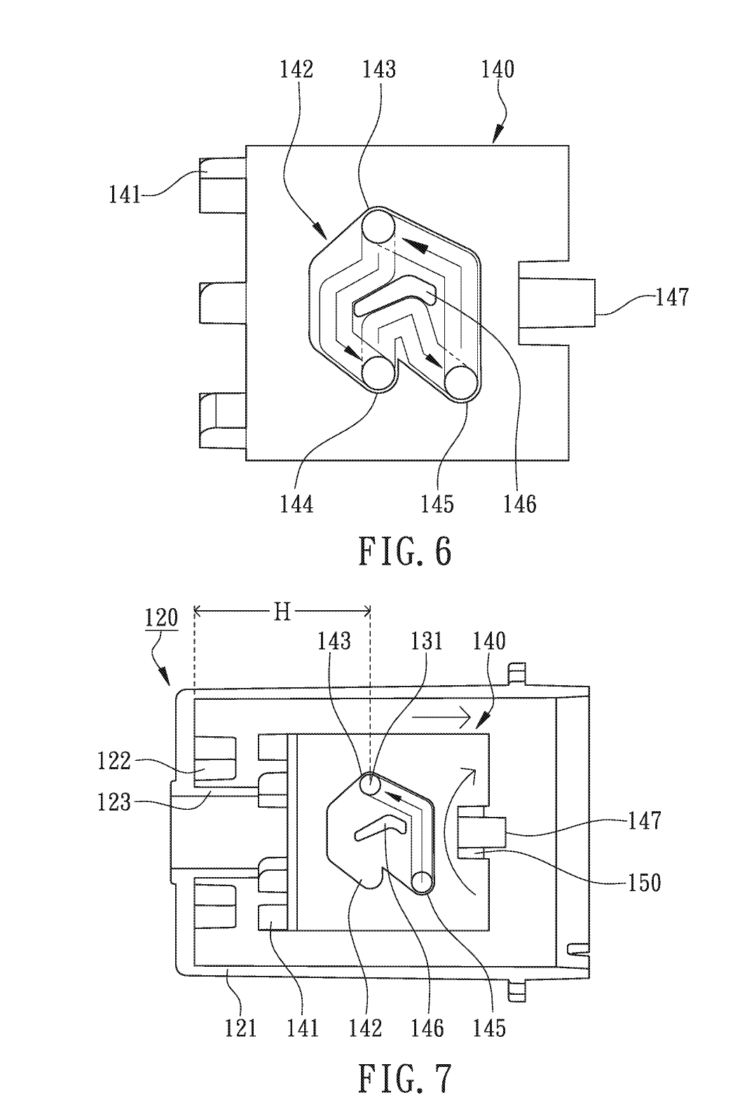

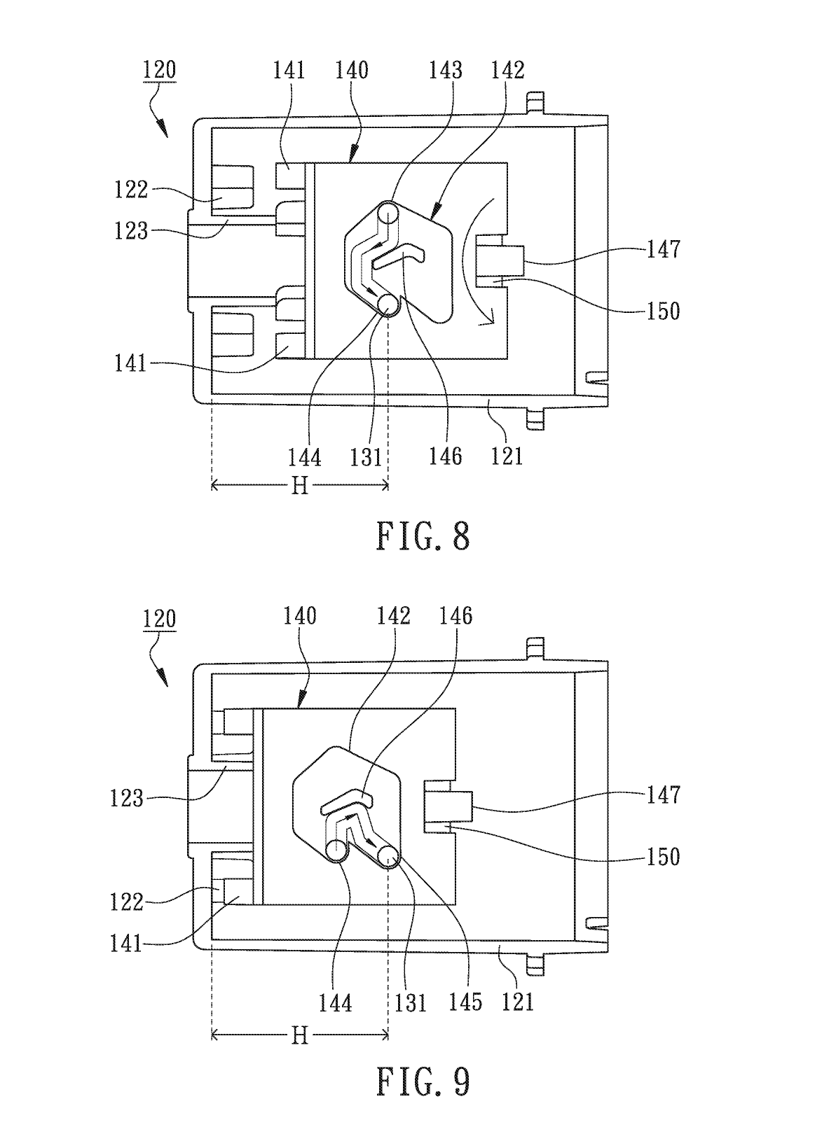

According to the first embodiment of the present invention, a clutch-type control device 100 for a cordless blind is illustrated in FIG. 1 of a three-dimensional assembly view and in FIG. 2 for a three-dimensional partial cross-sectional view. The clutch-type control device 100 comprises a force-return mechanism 110 and a breaking mechanism 120 where the force-return mechanism 110 is illustrated in FIG. 3 for a component disassembly view, the breaking mechanism 120 is illustrated in FIG. 4 for a component disassembly view and in FIG. 5 for a cross-sectional view component before joining a second shaft connecter 130. FIG. 6 is an illustration of a serial position movement of a gearshift lever of the second shaft connecter in the gearshift pattern of the clutch rotor of the clutch-type control device 100. FIG. 7 is an illustration of the position of the clutch rotor of the clutch-type control device corresponding to the outer housing when the cordless blind is lowered. FIG. 8 is an illustration of the position of the clutch rotor of the clutch-type control device corresponding to the outer housing when the cordless blind is lifted. FIG. 9 is an illustration of the position of the clutch rotor of the clutch-type control device corresponding to the outer housing when the cordless blind is stopped.

As shown in FIGS. 1 to 3, the force-return mechanism 110 includes a base 111, a first shaft connecter 112 installed inside the base 111, and an elastic element 113 installed inside the base 111 and interlocked with the first shaft connecter 112 for providing a return force for retracting the cordless blind. A blind control rod may pass through and interlocks with the first shaft connecter 112, i.e., the radially cross-sectional shape of the interlocking hole of the first shaft connecter 112 matches to the radially cross-sectional shape of the cordless blind control rod. For example, when the cross-sectional shape of the blind control rod is hexagonal or other non-circular shapes, the cross-sectional shape of the interlocking hole of the first shaft connecter 112 is the corresponding hexagonal or other corresponding non-circular shapes. In this embodiment, the first shaft connecter 112 is a force-return wheel and the elastic element 113 is a spiral spring. The force-return mechanism 110 further includes a reed gear 114 meshed with the first shaft connecter 112. The elastic element 113 furls in the reed gear 114 where one end of the elastic element 113 is connected to the first shaft connecter 112. To be more specific, the base 111 primarily composes of two base plates 111A each having a plurality of spacing rods 111B to provide space to accommodate the first shaft connecter 112, the elastic element 113 and the reed gear 114. For example, a plurality of fixing elements 111C such as screws pass through the spacing rod 111B of one base plate 111A and jointed to the corresponding spacing rod 111B of the other base plate 111A so that the base 111 is assembled from the two base plates 111A. When there is no external force, the elastic element 113 furls from the first shaft connecter 112 toward the reed gear 114 to cause the cordless blind to rise, and a return elastic force of the elastic element 113 is released. When the cordless blind experiences downward force, the elastic element 113 furls from the reed gear 114 toward the first shaft connecter 112 to restore the return elastic force.

As shown in FIG. 1, FIG. 2, FIG. 4, and FIG. 5, the breaking mechanism 120 includes an outer housing 121 fixed to the base 111, a second shaft connecter 130 accommodated inside the outer housing 121, and a clutch rotor 140 sleeved in the second shaft connecter 130. The outer housing 121 has an engaging chuck 122 at the inner bottom of the outer housing 121. A plurality of engaging teeth 141 corresponding to the engaging chuck 122 are disposed on one end of the clutch rotor 140 as shown in FIG. 4. In the present embodiment, the outer housing 121 is cylindrical where the engaging chuck 122 is located on the internal surface of the outer housing 121. A plurality of through holes are disposed on a plurality of external lips adjacent to the opening of the outer housing 121 where a plurality of screws pass through the through holes and are jointed to the base 111. Preferably, the outer housing 121 has a hollow axial rod 123 integrally connected inside the outer housing 121 to confine the axial movement of the second shaft connecter 130 and to let the blind control rod to pass through without any interlocking.

As shown in FIG. 2 and FIG. 4, the second shaft connecter 130 has a gearshift lever 131 extruded toward to the axle of the second shaft connecter 130. The gearshift lever 131 is a metal rod having two different diameters where a rod portion with a larger diameter is installed into an alignment hole of the second shaft connecter 130 and the other rod portion with a smaller diameter is extruded into a gearshift pattern 142 of the clutch rotor 140. Through the gearshift lever 131, the second shaft connecter 130 may drive the clutch rotor 140 to rotate, moreover, the clutch rotor 140 may move axially corresponding to the second shaft connecter 130 to execute the clutch engagement and disengagement. Whether the second shaft connecter 130 accommodated inside the outer housing 121 is rotating or stopped, the axial distance H between the gearshift lever 131 and the engaging chuck 122 is fixed as shown in FIG. 7, FIG. 8, and FIG. 9. To be more specific, the above-mentioned axial distance H is a constant ranging from 1.0 centimeters to 3.0 centimeters. More specifically, the axial distance H is a constant ranging from 1.5 centimeters to 2.0 centimeters. Preferably, the second shaft connecter 130 is a built-in cylindrical rotor where an axial connecting hole 132 is installed at the cylinder bottom of the second shaft connecter 130. The cylinder opening of the second shaft connecter 130 is toward the bottom of the outer housing 121 where the bottom of the second shaft connecter 130 is installed inside the cylinder opening of the outer housing 121. The hollow axial rod 123 of the outer housing 121 is aligned to the axial connecting hole 132 where the axial connecting hole 132 allows the blind control rod to pass through and interlock with the blind control rod, i.e., the shapes of the axial connecting hole 132 of the second shaft connecter 130 is corresponding to the shapes of the cross-section of the blind control rod. For example, when the cross-sectional shape of the blind control rod is hexagonal or other non-circular shapes, the cross-sectional shape of the axial connecting hole 132 is the corresponding hexagonal or other non-circular shapes.

As shown in FIG. 2, FIG. 4, and from FIG. 6 to FIG. 9, a dished gearshift pattern 142 is formed on an external radial surface of the clutch rotor 140 where the gearshift pattern 142 has a blind-lowering disengagement position 143, a blind-lifting disengagement position 144, and a blind-stopping engagement position 145 for providing an serial position movement of the gearshift lever 131 in the gearshift pattern 142, as shown in FIG. 6. As shown from FIG. 6 to FIG. 9, in the present embodiment, a first axial distance from the blind-stopping engagement position 145 to the engaging teeth 141 is greater than a second axial distance from the blind-lowering disengagement position 143 to the engaging teeth 141 and is also greater than a third axial distance from the blind-lifting disengagement position 144 to the engaging teeth 141. As shown in FIG. 7, when the gearshift lever 131 shifts from the blind-stopping engagement position 145 to the blind-lowering disengagement position 143, the cordless blind can move downward. As shown in FIG. 8, when the gearshift lever 131 shifts from the blind-lowering disengagement position 143 to the blind-lifting disengagement position 144, the cordless blind can move upward. As shown in FIG. 9, when the gearshift lever 131 shifts from the blind-lifting disengagement position 144 to the blind-stopping engagement position 145, the cordless blind is stopped. As shown in FIG. 6 and FIG. 9, the clutch rotor 140 may have a V-shaped guiding bar 146 located within the gearshift pattern 142 for adjusting and ensuring the movement of the gearshift lever 131 from the blind-lifting disengagement position 144 to the blind-stopping engagement position 145. Furthermore, a plurality of clamping portions 147 are installed on the other end of the clutch rotor 140 to clamp a friction ring 150 inside as shown in FIG. 5.

As shown in FIG. 7 and FIG. 8, when the gearshift lever 131 is aligned to either of the blind-lowering disengagement position 143 and the blind-lifting disengagement position 144, the engaging teeth 141 of the clutch rotor 140 are disengaged from the engaging chuck 122 of the outer housing 121 to rotate the second shaft connecter 130. As shown in FIG. 9, when the gearshift lever 131 is aligned to the blind-stopping engagement position 145, the engaging teeth 141 of the clutch rotor 140 are engaged with the engaging chuck 122 of the outer housing 121 to stop the second shaft connecter 130.

As shown in FIG. 4 and FIG. 5, in a more specific embodiment, the breaking mechanism 120 further includes a friction ring 150 sleeved in the clutch rotor 140 and hitched to the hollow axial rod 123 where at least a damper segment 151 is preferably installed between the friction ring 150 and the clutch rotor 140 to increase the rotation friction of the clutch rotor 140. The damper segment 151 may be a felt strip. Therefore, the friction ring 150 is non-rotatable as the same as the outer housing 121, but is movable in axial direction similar to the clutch rotor 140 for providing a rotation friction against the clutch rotor 140. The clutch rotor 140 rotates relative to the friction ring 150 where a friction force exists between the clutch rotor 140 and the friction ring 150. The clamping portions 147 of the clutch rotor 140 clamp the friction ring 150 so that the friction ring 150 does not slide out from the clutch rotor 140.

Therefore, the clutch-type control device 100 for a cordless blind revealed in the present invention accurately controls the stopped position of the cordless blind disregarding the mechanical fatigue of the force-return mechanism where the tolerance of the balanced weight also can be enlarged and the safety of cordless blind is further enhanced.

As shown in FIG. 2 and FIG. 4, for further comprehension, the breaking mechanism 120 of a clutch-type control device 100 for a cordless blind revealed by the present invention comprising an outer housing 121 for fixing to the base 111, a shaft connecter 130 accommodated inside the outer housing 121, and a clutch rotor 140 sleeved in the shaft connecter 130 where the base 111 may be one component of the force-return mechanism 110. In different embodiments, the base 111 may be an independent component separated from the force-return mechanism 110. The outer housing 121 has an engaging chuck 122. A plurality of engaging teeth 141 are disposed on one end of the clutch rotor 140. As shown in FIG. 2 and FIG. 9, when the shaft connecter 130 installed inside the outer housing 121 rotates from clockwise to counterclockwise corresponding to the lifting and the lowering of the blind, the shaft connecter 130 drives the clutch rotor 140 like gear shifting to axially move toward the engaging chuck 122 within the shaft connecter 130 so that the engaging teeth 141 of the clutch rotor 140 are engaged with the engaging chuck 122 of the outer housing 121.

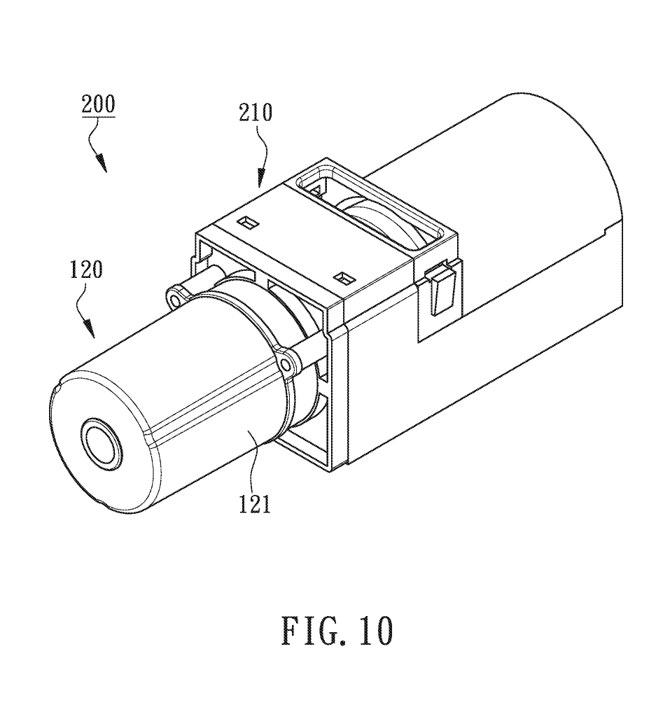

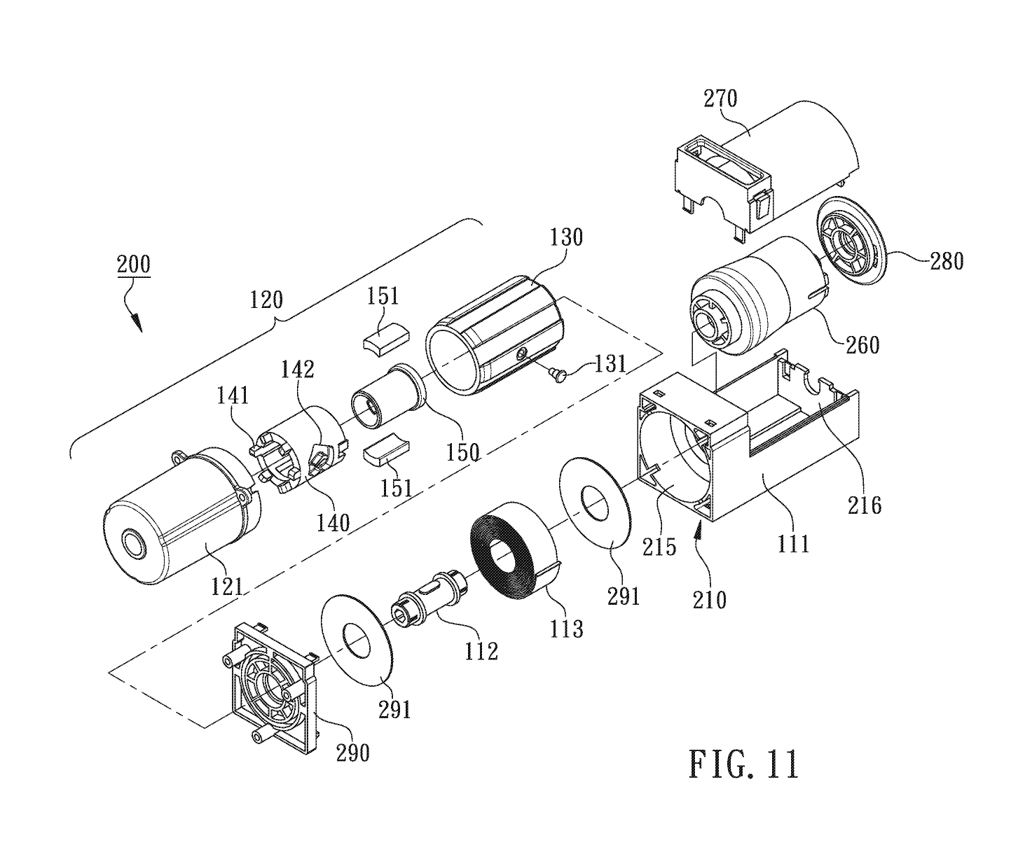

According to the second embodiment of the present invention, when the components have the same names and functions as described in the first embodiment, the figure numbers are followed without further detail description. Another clutch-type control device 200 for a cordless blind is illustrated in FIG. 10 for a three-dimensional assembly view and in FIG. 11 for a component disassembly view. The clutch-type control device 200 comprises a force-return mechanism 210 and a breaking mechanism 120. The breaking mechanism 120 in the second embodiment has the same structure as the one in the first embodiment.

As shown in FIG. 10 and FIG. 11, the force-return mechanism 210 includes a base 111, a first shaft connecter 112 installed inside the base 111, and an elastic element 113 installed inside the base 111 and interlocked with the first shaft connecter 112 to provide a retracting elastic force for the cordless blind. The breaking mechanism 120 includes an outer housing 121 fixed to the base 111, a second shaft connecter 130 accommodated inside the outer housing 121, and a clutch rotor 140 sleeved in the second shaft connecter 130. The outer housing 121 has an engaging chuck 122. And, a plurality of engaging teeth 141 are disposed on one end of the clutch rotor 140. The second shaft connecter 130 has a gearshift lever 131 extruded toward to the axle of the second shaft connecter 130. Whether the second shaft connecter 130 accommodated inside the outer housing 121 is rotated or stopped, an axial distance between the gearshift lever 131 and the engaging chuck 122 is fixed.

As shown from FIG. 6 to FIG. 9, a dished gearshift pattern 142 is formed on the external radial surface of the clutch rotor 140 where the gearshift pattern 142 has a blind-lowering disengagement position 143, a blind-lifting disengagement position 144, and a blind-stopping engagement position 145 for a serial position movement of the gearshift lever 131 in the gearshift pattern 142. When the gearshift lever 131 is aligned to either of the blind-lowering disengagement position 143 and the blind-lifting disengagement position 144, the engaging teeth 141 of the clutch rotor 140 are disengaged from the engaging chuck 122 of the outer housing 121 so that the second shaft connecter 130 can rotate. When the gearshift lever 131 is aligned to the blind-stopping engagement position 145, the engaging teeth 141 of the clutch rotor 140 are engaged with the engaging chuck 122 of the outer housing 121 so that the second shaft connecter 130 can not rotate.

As shown in FIG. 11, in the present embodiment, the first shaft connecter 112 is an axle sleeve and the elastic element 113 is a spiral spring. The base 111 has a first chamber 215 and a second chamber 216 where the first shaft connecter 112 and the elastic element 113 are installed inside the first chamber 215. The internal end of the elastic element 113 is connected to the first shaft connecter 112 and the external end of the elastic element 113 is connected to the first chamber 215. A string spool 260 is installed inside the second chamber 216 to furl the blind control string and to let a blind control rod to pass through with connection relationship so that the string spool 260 rotates synchronously with the blind control rod. To be more specific, a top cover 270 covers the second chamber 216 to avoid the exposure of the string spool 260. An alignment ring 280 is installed between the top cover 270 and the base 111 far away from the first chamber 215 to keep the axle of the blind control rod to rotate without trembles. Moreover, the base 111 further includes a side cover 290 to cover the opening of the first chamber 215 where a plurality of blocking plates 291 located at two opposing sides of the elastic element 113 in the first chamber 215 to avoid distortion and deformation.

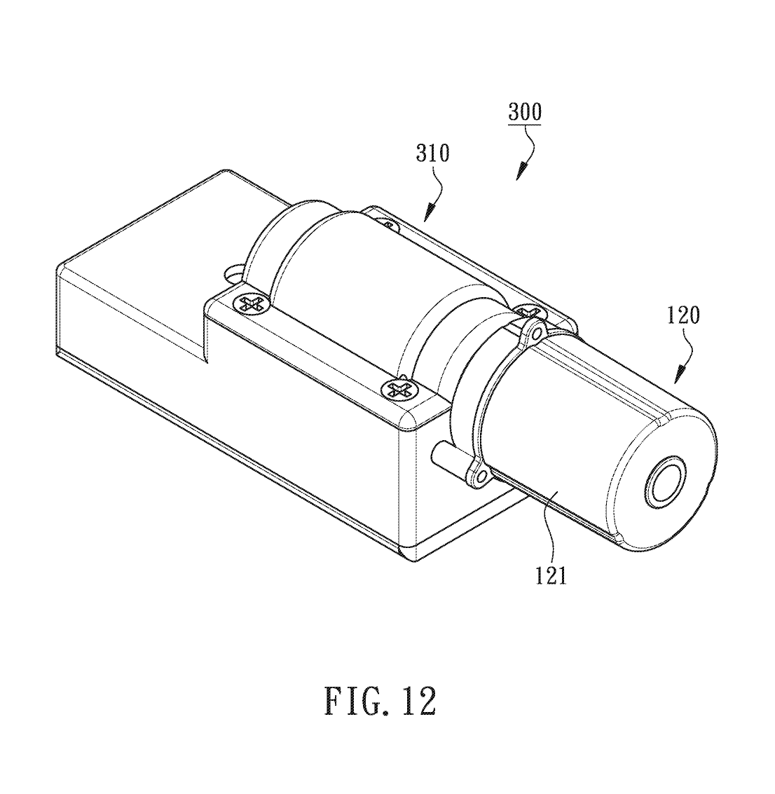

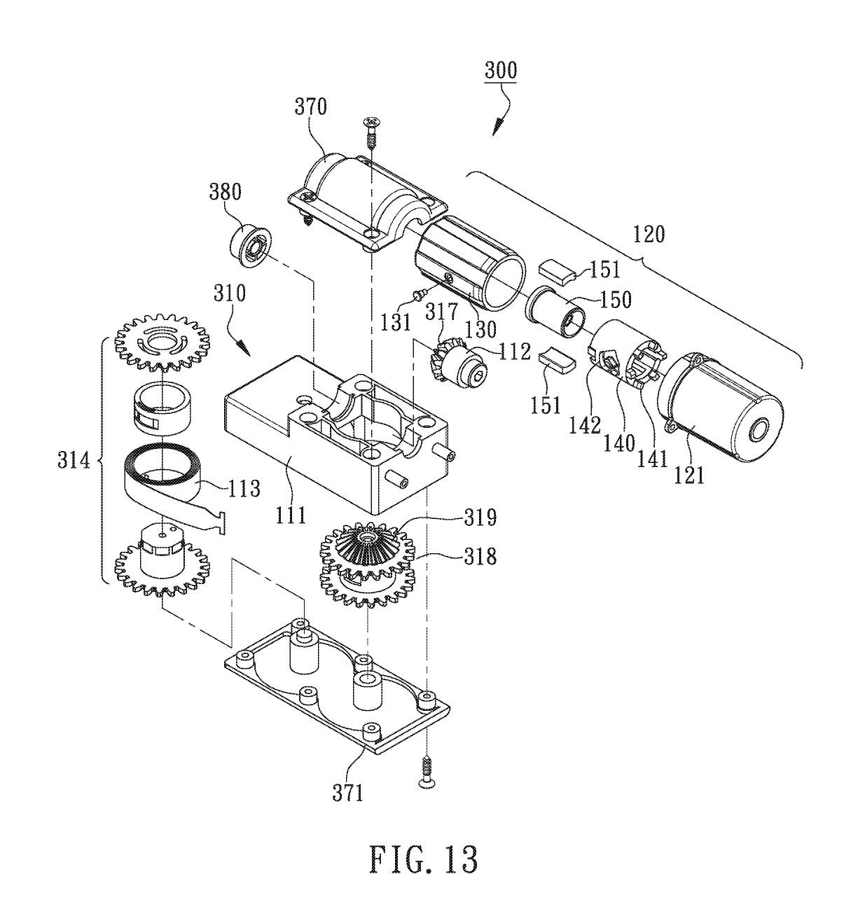

According to the third embodiment of the present invention, when the components have the same names and functions as described in the first embodiment, the figure numbers are followed without further detail description. Another clutch-type control device 300 for a cordless blind is illustrated in FIG. 12 for a three-dimensional assembly view and in FIG. 13 for a component disassembly view. The clutch-type control device 300 comprises a force-return mechanism 310 and a breaking mechanism 120. The breaking mechanism 120 in the third embodiment has the same structure as the one in the first embodiment.

As shown in FIG. 12 and FIG. 13, the force-return mechanism 310 includes a base 111, a first shaft connecter 112 installed inside the base 111, and an elastic element 113 installed inside the base 111 and interlocked with the first shaft connecter 112 to provide a retracting elastic force for the cordless blind. The breaking mechanism 120 includes an outer housing 121 fixed to the base 111, a second shaft connecter 130 accommodated inside the outer housing 121, and a clutch rotor 140 sleeved in the second shaft connecter 130. The outer housing 121 has an engaging chuck 122. And, a plurality of engaging teeth 141 are disposed on one end of the clutch rotor 140. The second shaft connecter 130 has a gearshift lever 131 extruded toward to the axle of the second shaft connecter 130. Whether the second shaft connecter 130 accommodated inside the outer housing 121 is rotated or stopped, an axial distance H between the gearshift lever 131 and the engaging chuck 122 is fixed as shown in FIGS. 7, 8 and 9.

As shown from FIG. 6 to FIG. 9, a dished gearshift pattern 142 is formed on the external radial surface of the clutch rotor 140 where the gearshift pattern 142 has a blind-lowering disengagement position 143, a blind-lifting disengagement position 144, and a blind-stopping engagement position 145 for providing a serial position movement of the gearshift lever 131, as shown in FIG. 6 again. When the gearshift lever 131 is aligned to either of the blind-lowering disengagement position 143 and the blind-lifting disengagement position 144, the engaging teeth 141 of the clutch rotor 140 are disengaged from the engaging chuck 122 of the outer housing 121 so that the second shaft connecter 130 can rotate. When the gearshift lever 131 is aligned to the blind-stopping engagement position 145, the engaging teeth 141 of the clutch rotor 140 are engaged with the engaging chuck 122 of the outer housing 121 so that the second shaft connecter 130 can not rotate.

As shown in FIG. 13, in the present embodiment, one end of the first shaft connecter 112 has a transmission bevel gear 317 and the elastic element 113 is a spiral spring. The force-return mechanism 310 further includes a flat spring bevel gear 318 and a reed gear 314 interlocked with the flat spring bevel gear 318. The elastic element 113 furls inside the reed gear 314 where one end of the elastic element 113 is connected to the flat spring bevel gear 318. The transmission bevel gear 317 is interlocked with a bevel gear portion 319 of the flat spring bevel gear 318. A top cover 370 covers an upper chamber of the base 111 so that the first shaft connecter 112 installed inside the upper chamber is not exposed. A bottom plate 371 covers the bottom chamber of the base 111 so that the flat spring bevel gear 318 and the reed gear 314 are not exposed. Furthermore, an alignment ring 380 is installed between the top cover 370 and the base 111 away from the breaking mechanism 120 to keep the axle of the blind control rod to rotate without trembles.

The above description of embodiments of this invention is intended to be illustrative but not limited. Other embodiments of this invention are obvious to those skilled in the art in view of the above disclosure which are still covered by and within the scope of the present invention even with any modifications, equivalent variations, and adaptations.

What is claimed is:

1. A clutch-type control device for a cordless blind comprising:
a force-return mechanism including a base, a first shaft connecter installed inside the base, and an elastic element installed inside the base and interlocked with the first shaft connecter for providing a return force for retracting the cordless blind; and
a breaking mechanism including an outer housing fixed to the base, a second shaft connecter installed inside the outer housing, and a clutch rotor sleeved in the second shaft connecter, wherein the outer housing has an engaging chuck, wherein a plurality of engaging teeth are disposed at one end of the clutch rotor, wherein the second shaft connecter has a gearshift lever extruded toward the axle of the second shaft connecter, whether the second shaft connecter installed inside the outer housing is rotated or stopped, an axial distance between the gearshift lever and the engaging chuck is fixed, wherein a dished gearshift pattern is formed on an outer radial surface of the clutch rotor, wherein the gearshift pattern has a blind-lowering disengagement position, a blind-lifting disengagement position, and a blind-stopping engagement position to provide a serial position movement for the gearshift lever, wherein when the gearshift lever is aligned to either of the blind-lowering disengagement position and the blind-lifting disengagement position, the engaging teeth of the clutch rotor is disengaged from the engaging chuck so that the second shaft connecter is under rotatable condition, wherein when the gearshift lever is aligned to the blind-stopping engagement position, the engaging teeth of the clutch rotor are engaged with the engaging chuck of the outer housing so that the second shaft connecter is under nonrotatable condition.

2. The clutch-type control device as claimed in claim 1, wherein the clutch rotor has a V-shaped guiding bar located within the gearshift pattern for adjusting and ensuring the movement of the gearshift lever from the blind-lifting disengagement position to the blind-stopping engagement position.

3. The clutch-type control device as claimed in claim 1, wherein the shaft connecter is a built-in cylindrical rotor wherein an axial connecting hole is installed at the cylinder bottom of the second shaft connecter.

4. The clutch-type control device as claimed in claim 3, wherein the outer housing has a hollow axial rod integrally connected inside the outer housing, wherein the hollow axial rod is aligned to the axial connecting hole.

5. The clutch-type control device as claimed in claim 4, wherein the breaking mechanism further comprises a friction ring sleeved in the clutch rotor and hitched to the hollow axial rod.

6. The clutch-type control device as claimed in claim 5, wherein at least a damper segment is installed between the friction ring and the clutch rotor.

7. The clutch-type control device as claimed in claim 1, wherein an axial distance from the blind-stopping engagement position to the engaging teeth is greater than an axial distance from the blind-lowering disengagement position to the engaging teeth and is also greater than an axial distance from the blind-lifting disengagement position to the engaging teeth.

8. The clutch-type control device as claimed in claim 1, wherein the first shaft connecter is a force-return wheel, wherein the elastic element is a spiral spring, and the force-return mechanism further including a reed gear meshed with the first shaft connecter, wherein the elastic element furls in the reed gear, wherein one end of the elastic element is connected to the first shaft connecter.

9. The clutch-type control device as claimed in claim 1, wherein the first shaft connecter is an axle sleeve and the elastic element is a spiral spring, wherein the base has a first chamber and a second chamber, wherein the first shaft connecter and the elastic element are installed inside the first chamber, wherein one end of the elastic element is connected to the first shaft connecter and the other end of the elastic element is fixed in the first chamber, and wherein a string spool is installed inside the second chamber.

10. The clutch-type control device as claimed in claim 1, wherein one end of the first shaft connecter has a transmission bevel gear, wherein the elastic element is a spiral spring, and the force-return mechanism further comprising a flat spring bevel gear and a reed gear interlocked with the flat spring bevel gear, wherein the elastic element furls inside the reed gear, wherein one end of the elastic element is connected to the flat spring bevel gear, and wherein the transmission bevel gear is interlocked with a bevel gear portion of the flat spring bevel gear.

11. A breaking mechanism of a clutch-type control device for a cordless blind, comprising:
an outer housing for fixing to a base;
a shaft connecter accommodated inside the outer housing; and
a clutch rotor sleeved in the shaft connecter;
wherein the outer housing has an engaging chuck, wherein a plurality of engaging teeth are disposed on one end of the clutch rotor, wherein when the shaft connecter installed inside the outer housing rotates from clockwise to counterclockwise corresponding to the lifting and the lowering of the cordless blind respectively, the shaft connecter drives the clutch rotor like gear shifting to axially move toward the engaging chuck within the shaft connecter so that the engaging teeth of the clutch rotor are engaged with the engaging chuck of the outer housing.

12. The breaking mechanism as claimed in claim 11, wherein the shaft connecter has a gearshift lever extruded toward the axle of the shaft connecter, wherein a dished gearshift pattern is formed on an outer radial surface of the clutch rotor, wherein the gearshift pattern has a blind-lowering disengagement position, a blind-lifting disengagement position, and a blind-stopping engagement position to provide a serial position movement for the gearshift lever.

13. The breaking mechanism as claimed in claim 12, wherein the clutch rotor has a V-shaped guiding bar located within the gearshift pattern for adjusting and ensuring the movement of the gearshift lever from the blind-lifting disengagement position to the blind-stopping engagement position.

14. The breaking mechanism as claimed in claim 11, wherein the shaft connecter is a built-in cylindrical rotor, wherein an axial connecting hole is installed at the cylinder bottom of the shaft connecter.

15. The breaking mechanism as claimed in claim 14, wherein the outer housing has a hollow axial rod integrally connected inside the outer housing, wherein the hollow axial rod is aligned to the axial connecting hole.

16. The breaking mechanism as claimed in claim 15, wherein the breaking mechanism further comprises a friction ring sleeved in the clutch rotor and hitched to the hollow axial rod.

17. The breaking mechanism as claimed in claim 16, wherein at least a damper segment is installed between the friction ring and the clutch rotor.

18. The breaking mechanism as claimed in claim 11, wherein an axial distance from the blind-stopping engagement position to the engaging teeth is greater than an axial distance from the blind-lowering disengagement position to the engaging teeth and is also greater than an axial distance from the blind-lifting disengagement position to the engaging teeth.
